(19) United States
(12) Patent Application Publication
(10) Pub. No.: US 2022/0100556 A1
(43) Pub. Date: Mar. 31, 2022

(54) ELECTRONIC DEVICE, AND METHOD FOR MANAGING LIFE CYCLE OF PLURALITY OF APPLICATIONS EXECUTED IN ELECTRONIC DEVICE

(71) Applicant: SAMSUNG ELECTRONICS CO., LTD., Suwon-si, Gyeonggi-do (KR)

(72) Inventors: Hyeoncheon JO, Suwon-si, Gyeonggi-do (KR); Jaeseok YOON, Suwon-si, Gyeonggi-do (KR); Youngseok LIM, Suwon-si, Gyeonggi-do (KR); Sungyul CHOE, Suwon-si, Gyeonggi-do (KR); Jaeyung YEO, Suwon-si, Gyeonggi-do (KR)

(21) Appl. No.: 17/427,338

(22) PCT Filed: Sep. 27, 2019
(86) PCT No.: PCT/KR2019/012628

§ 371 Date: Jul. 30, 2021

(30) Foreign Application Priority Data
Feb. 14, 2019 (KR) 10-2019-0017105

(51) Int. Cl. G06F 9/48; G06F 9/50

(52) U.S. Cl. CPC G06F 9/485; G06F 9/50

(57) ABSTRACT

Various embodiments of the present invention provide an electronic device, and a method for managing the life cycle of a plurality of applications executed in the electronic device, the electronic device comprising: a display; at least one processor operably connected to the display; and a memory operably connected to the processor, wherein the memory stores a first application program and a second application program which include user interfaces, and the memory stores instructions for allowing, when executed, the processor to request status information related to the first application program, receive the status information related to the first application program, and display, on the display, a user interface of the second application program including content generated on the basis of at least some the received status information, so that the first application program and the second application program can be linkably operated. Other various embodiments are possible.

### CROSS-REFERENCE TO RELATED APPLICATIONS

This application is a national stage application of International Application No. PCT/KR2019/012628 designating the United States, filed on Sep. 27, 2019, in the Korean Intellectual Property Receiving Office and claiming priority to Korean Patent Application No. 10-2019-0017105, filed Feb. 14, 2019, in the Korean Intellectual Property Office, the disclosures of which are incorporated by reference herein in their entireties.

### FIELD

The disclosure relates to an electronic device and a method for managing life cycles of a plurality of applications executed in the electronic device.

### DESCRIPTION OF RELATED ART

As technologies of electronic devices such as smart phones and tablet PCs develop, types of applications executable in the electronic devices are diversifying.

The electronic device can execute an application to offer various functions to the user. The electronic device is capable of multitasking that simultaneously executes a plurality of applications.

In the multitasking, applications may be switched between a foreground and a background.

The plurality of applications executed in the electronic device may have a foreground state in which they are executed with being displayed on the screen, and a background state in which they are executed without being displayed on the screen.

The electronic device transmits a life cycle event related to an application life cycle to each individual application, so a plurality of applications may operate independently without being linked to each other.

In this case, an application running in the foreground and an application running in the background may not be used at the same time. In addition, unnecessary overhead and time consumption may occur in a switching process of a plurality of applications.

### SUMMARY

Embodiments of the disclosure provide an electronic device that allows a plurality of applications to share status information (e.g., life cycle event information and additional information) about one application transmitted through a framework.

Embodiments of the disclosure provide a method for managing the life cycles of the plurality of applications executed in the electronic device may be provided.

According to an example embodiment of the disclosure, an electronic device may include: a display; at least one processor operatively connected to the display; and a memory operatively connected to the processor. The memory may store a first application program and a second application program each including a user interface. The memory may store instructions that, when executed, cause\ the processor to: request status information related to the first application program; receive the status information related to the first application program; and control the display to display the user interface of the second application program including content generated based at least in part on the received status information.

According to an example embodiment of the disclosure, a method for managing life cycles of a first application program and a second application program executed in an electronic device may include: transmitting, at a framework, status information about the first application program to the first application program under control of a processor; sending, at a life cycle manager, a request for the status information to the first application program; receiving, at the life cycle manager, the status information about the first application program; and displaying, on a display, a user interface of the second application program including content generated based at least in part on the received status information.

According to an example embodiment of the disclosure, a computer-readable storage medium may store a program performing a method for managing life cycles of a first application program and a second application program executed in an electronic device. The method may include: transmitting, at a framework, status information about the first application program to the first application program under control of a processor; sending, at a life cycle manager, a request for the status information to the first application program; receiving, at the life cycle manager, the status information about the first application program; and displaying, on a display, a user interface of the second application program including content generated based at least in part on the received status information.

According to various example embodiments of the disclosure, a plurality of applications may operate in connection with each other by sharing status information about one application transmitted through a framework. Therefore, the plurality of applications may operate simultaneously without being independent of each other.

According to various example embodiments of the disclosure, a plurality of applications may share status information about one application transmitted through a framework, so that unnecessary overhead and time consumption occurring in a switching process of the plurality of applications between a foreground state and a background state can be reduced.

### BRIEF DESCRIPTION OF THE DRAWINGS

The above and other aspects, features and advantages of certain embodiments of the present disclosure will be more apparent from the detailed description, taken in conjunction with the accompanying drawings, in which:

FIG. 1 is a block diagram illustrating an example electronic device in a network environment according to various embodiments;

FIG. 2 is a block diagram illustrating an example program according to various embodiments;

FIG. 3 is a block diagram illustrating an example configuration of an electronic device according to various embodiments;

FIG. 4 is a block diagram illustrating an example configuration of a life cycle manager applied to an electronic device according to various embodiments;

FIG. 5 is a diagram illustrating an example of managing life cycles of a plurality of applications executed in an electronic device according to various embodiments;

FIG. 6 is a flowchart illustrating an example method for managing life cycles of a plurality of applications executed in an electronic device according to various embodiments.

### DETAILED DESCRIPTION

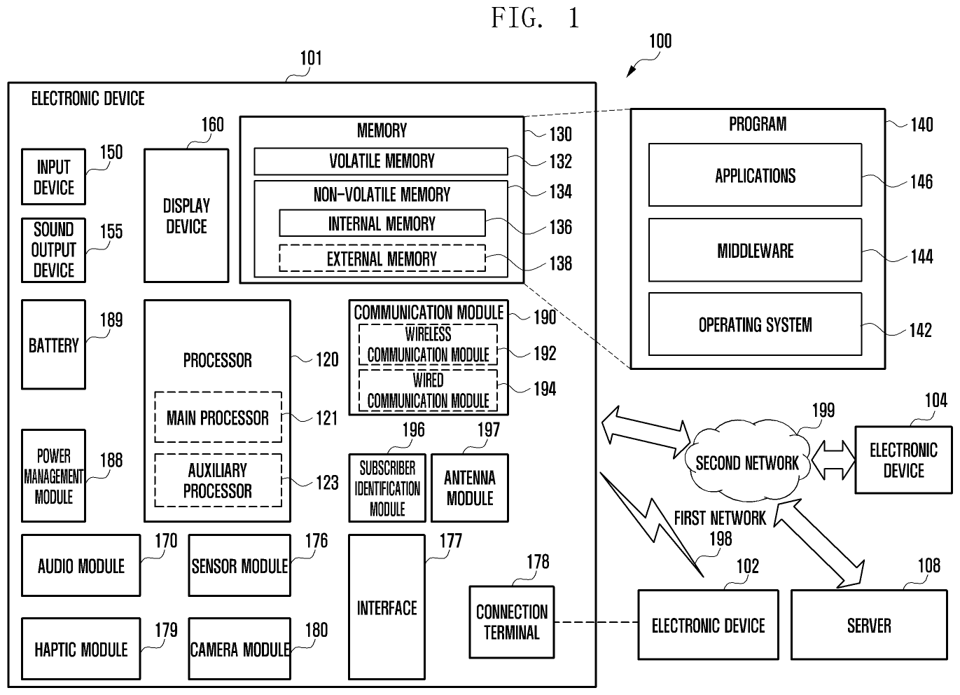

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197.

In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform certain data processing or computation. According to an embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121. The auxiliary processor 123 may control at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application).

According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store certain data used by at least one component (e.g., the processor 120 or the sensor module 176) of the electronic device 101. The certain data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or a headphone of an external electronic device (e.g., an electronic device 102) directly (e.g., wiredly) or wirelessly coupled with the electronic device 101. The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector). The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These certain types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit/receive a signal or power to/from an external entity (e.g., an external electronic device). According to some embodiments, the antenna module 197 may be formed of a conductor or a conductive pattern and may further include any other component (e.g., RFIC). According to an embodiment, the antenna module 197 may include one or more antennas, which may be selected to be suitable for a communication scheme used in a specific communication network, such as the first network 198 or the second network 199 by, for example, the communication module 190. Through the selected at least one antenna, a signal or power may be transmitted or received between the communication module 190 and the external electronic device.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

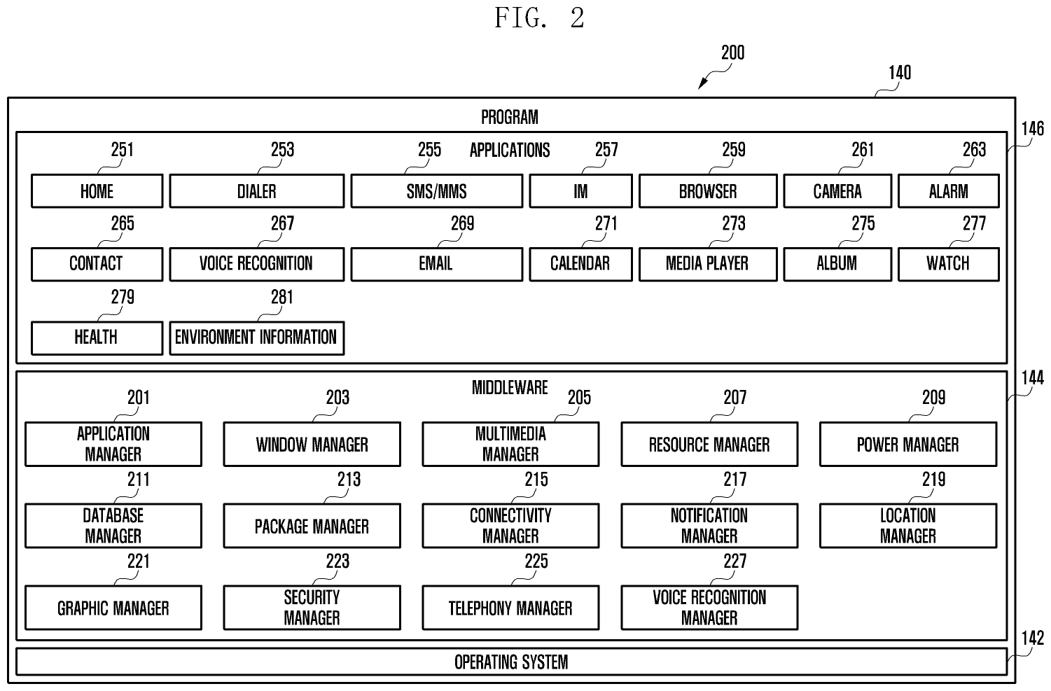

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example. FIG. 2 is a block diagram 200 illustrating an example program 140 according various embodiments. According to an embodiment, the program 140 may include an operating system 142 for controlling resources of the electronic device 101, a middleware 144, or applications 146 executable on the operating system 142. The operating system 142 may include, for example, Android™ iOS™, Windows™, Symbian™, Tizen™, or Bada™. At least part of the program 140 may be preloaded in the electronic device 101 at the time of manufacture or may be downloaded or updated from an external electronic device (e.g., the electronic device 102 or 104 or the server 108) when used by a user.

The operating system 142 may control management (e.g., allocation or retrieval) of one or more system resources (e.g., process, memory, or power) of the electronic device 101. Additionally or alternatively, the operating system 142 may include one or more driver programs for driving other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the applications 146 so that functions or information provided from one or more resources of the electronic device 101 may be used by the applications 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201 may manage, for example, the life cycles of the applications 146. The window manager 203 may manage, for example, one or more GUI resources used for the screen. The multimedia manager 205 may identify one or more formats required for playing media files and, using a codec proper to a selected format, encode or decode a corresponding one of the media files. The resource manager 207 may manage, for example, source codes of the applications 146 or a space of the memory 130. The power manager 209 may manage, for example, capacity, temperature or power of the battery 189 and, using corresponding information, determine or provide related information necessary for the operation of the electronic device 101. According to an embodiment, the power manager 209 may interoperate with a basic input/output system (BIOS) (not shown) of the electronic device 101.

The database manager 211 may generate, search, or modify, for example, a database for use by the applications 146. The package manager 213 may manage, for example, installation or update of an application distributed in the form of a package file. The connectivity manager 215 may manage, for example, a wireless connection or a direct connection between the electronic device 101 and an external electronic device. The notification manager 217 may provide, for example, a function of notifying the occurrence of a specified event (e.g., an incoming call, a message, or an alarm) to the user. The location manager 219 may manage, for example, location information of the electronic device 101.

The graphic manager 221 may manage, for example, one or more graphical effects to be provided to user or a related user interface.

The security manager 223 may provide, for example, system security or user authentication. The telephony manager 225 may manage, for example, a voice call function or a video call function provided by the electronic device 101. The voice recognition manager 227 may, for example, transmit user's voice data to the server 108 and receive, from the server 108, a command corresponding to a function to be performed in the electronic device 101 based at least in part on the voice data, or text data converted based at least in part on the voice data. According to an embodiment, the middleware 144 may delete part of existing components or add new components dynamically. According to an embodiment, at least a part of the middleware 144 may be included as a part of the operating system 142 or implemented as software separate from the operating system 142. The applications 146 may include a home application 251, a dialer application 253, an SMS/MMS application 255, an instant message (IM) application 257, a browser application 259, a camera application 261, an alarm application 263, a contact application 265, a voice recognition application 267, an email application 269, a calendar application 271, a media player application 273, an album application 275, a watch application 277, a health application 279 (e.g., measuring biometric information such as exercise amount or blood sugar), or an environmental information application 281 (e.g., measuring atmospheric pressure, humidity, or temperature). According to an embodiment, the applications 146 may further include an information exchange application (not shown) for supporting information exchange between the electronic device 101 and an external electronic device. The information exchange application may include, for example, a notification relay application configured to transmit specific information (e.g., call, message, or alarm) to the external electronic device, or a device management application configured to manage the external electronic device.

The notification relay application may transmit, for example, notification information corresponding to a specified event (e.g., mail reception) generated in another application (e.g., the email application 269) of the electronic device 101 to the external electronic device. Additionally or alternatively, the notification relay application may receive notification information from the external electronic device and provide it to the user of the electronic device 101. The device management application may control, for example, the power (e.g., turn-on or turn-off) or function (e.g., brightness, resolution or focus of the display device 160 or the camera module 180) of the external electronic device communicating with the electronic device 101, or some components thereof (e.g., the display device 160 or the camera module 180). Additionally or alternatively, the device management application may support the installation, deletion, or update of applications operating in the external electronic device. The electronic device according to certain embodiments may be one of certain types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that certain embodiments of the present disclosure and the terms used therein are not intended to limit the technological features set forth herein to particular embodiments and include certain changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Certain embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The machine-readable storage medium may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to certain embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to certain embodiments, each component (e.g., a module or a program) of the above-described components may include a single entity or multiple entities. According to certain embodiments, one or more of the above-described components may be omitted, or one or more other components may be added. Alternatively or additionally, a plurality of components (e.g., modules or programs) may be integrated into a single component. In such a case, according to certain embodiments, the integrated component may still perform one or more functions of each of the plurality of components in the same or similar manner as they are performed by a corresponding one of the plurality of components before the integration. According to certain embodiments, operations performed by the module, the program, or another component may be carried out sequentially, in parallel, repeatedly, or heuristically, or one or more of the operations may be executed in a different order or omitted, or one or more other operations may be added.

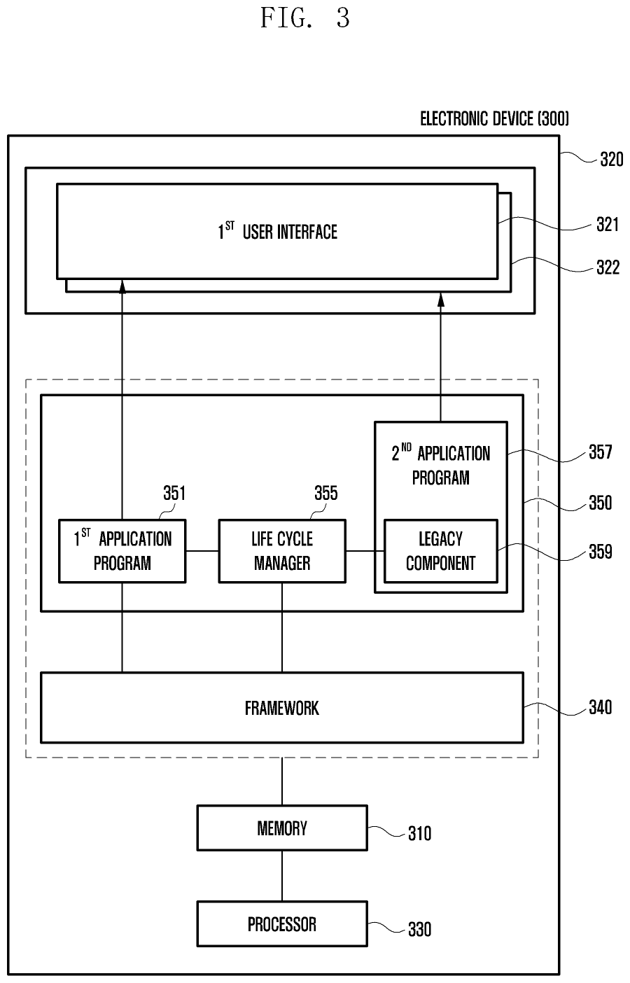

FIG. 3 is a block diagram illustrating an example configuration of an electronic device according to various embodiments.

Referring to FIG. 3, an electronic device 300 according to various embodiments may include a memory 310, a display 320, and a processor (e.g., including processing circuitry) 330.

According to various embodiments, the electronic device 300 (e.g., the electronic device 101 in FIG. 1) may include, for example, and without limitation, at least one of a smart phone, a tablet PC, a desktop, a laptop, or a wearable device. The memory 310 may include the memory 130 shown in FIG. 1. The display 320 may include the display device 160 shown in FIG. 1. The processor 330 may include the processor 120 shown in FIG. 1. The memory 310, the display 320, and the processor 330 may be operatively connected. According to an embodiment, the memory 310 may include a framework 340 and an application layer 350. The memory 310 may store instructions that, when executed, cause the processor 330 to provide the framework 340 and the application layer 350 that interfaces with the framework 340. The memory 310 may store a first application program 351 and a second application program 357 included in the application layer 350. The first application program 351 may include a first user interface 321. The second application program 357 may include a second user interface 322.

According to various embodiments, the memory 310 may store a program for controlling the overall operation of the electronic device 300 (e.g., the program 140 in FIGS. 1 and 2) and various data. The memory 310 may store a user interface (e.g., the first user interface 312 and the second user interface 322) provided through the display 320 in the electronic device 300, and various kinds of setting information required when the electronic device 300 processes a function. The memory 310 may store instructions that, when executed, operate by the processor 330.

According to an embodiment, the framework 340 may provide status information (e.g., life cycle event information and additional information) about the first application program 351 and/or the second application program 357 included in the application layer 350 to the application layer 350. The framework 340 may receive status information (e.g., life cycle event information and additional information) about the first application program 351 and/or the second application program 357 included in the application layer 350 from the application layer 350.

According to various embodiments, the framework 340 may control management (e.g., allocation or retrieval) of one or more system resources (e.g., process, memory, or power) of the electronic device 300. The framework 340 may include one or more driver programs for driving other hardware devices (e.g., the display 320) of the electronic device 300. The framework 340 may be software (e.g., the program 140 in FIGS. 1 and 2) implemented by the processor 330. Instructions for implementing the framework 340 may be stored in the memory 310. The framework 340 may include the operating system 142 shown in FIGS. 1 and 2.

According to an embodiment, the application layer 350 may include the first application program 351, a life cycle manager 355, and the second application program 357. The first application program 351 may include, for example, the home application 251 shown in FIG. 2 or a launcher. The second application program 357 may include, for example, the voice recognition application 267 shown in FIG. 2 or a voice-based assistant program.

According to various embodiments, although the application layer 350 is described as including the first application program 351 and the second application program 357 in FIG. 3, the application layer 350 may include a plurality of other application programs (e.g., the applications 146 in FIG. 2). According to an embodiment, the application layer 350 may receive status information (e.g., life cycle event information and additional information) about the first application program 351 and/or the second application program 357 from the framework 340. The first application program 351 may be executed in the foreground. The second application program 357 may be executed in the background. The first application program 351 may be executed in the background. The second application program 357 may be executed in the foreground.

According to an embodiment, the status information may include first life cycle event information or second life cycle information. For example, the first life cycle event information may be transmitted to the first application program 351. The second life cycle information may be transmitted to the life cycle manager 355 or the second application program 357. Each of the first life cycle event information and the second life cycle information may include information for allocating or removing resources to or from the first and second application programs 351 and 357 or starting or stopping a predetermined operation. According to an embodiment, the status information (e.g., first life cycle event information) about the first application program 351 executed in the foreground may include information described in Table 1 below.

TABLE 1

| | |
|---|---|
| onCreated | Created initially |
| onStarted | Starts to be displayed partly on screen |
| onResumed | Displayed fully on screen |
| onPaused | Starts to be displayed only in part on screen |
| onStopped | Not displayed on screen |
| onDestroyed | Completely ended |
| onWindowFocusChanged | Brings input focus while displayed on screen |
| onConfigurationChanged | Needs to update screen due to change in screen |

According to an embodiment, the status information (e.g., second life cycle event information) about the second application program 357 executed in the background may include information described in Table 2 below.

TABLE 2

| | |
|---|---|
| onCreated | Created initially |
| onStartCommand | Commands for operation are transmitted |
| onBind | Linked to other application programs |
| nUnBind | Disconnected from other application programs |
| onDestroyed | Completely ended |

According to various embodiments, the status information (e.g., first life cycle event information) about the first application program 351 may be transmitted to the life cycle manager 355. The first application program 351 may transmit first additional information different from the first life cycle event information to the life cycle manager 355.

According to an embodiment, the first additional information may include touch information of the first application program 351 entered through the display 320, and key and voice information about the first application program 351 entered through an input device (e.g., the input device 150 in FIG. 1). The first additional information may include information (e.g., the configuration of the electronic device 300, the rotation of the display 320, or the GPS location of the electronic device 300) acquired by the electronic device 300 itself. The first additional information may include information about a region, location, and coordinates of the first application program 351 displayed on the display 320. The first additional information may include command information for explicitly operating the second application program 357 in accordance with a business logic of the first application program 351. The first additional information may include setting information stored in the memory 310 to link the first application program 351 and the second application program 357.

According to an embodiment, the life cycle manager 355 may transmit the status information (e.g., first life cycle event information and/or first additional information), received from the first application program 351, to the second application program 357. The status information may be shared between the first application program 351 and the second application program 357. Using the status information (e.g., first life cycle event information and/or first additional information), the life cycle manager 355 may determine whether the first application program 351 is running in the foreground or running in the background. The life cycle manager 355 may be configured to share, for example, information updated in the first application program 351 running in the foreground with the second application program 357 running in the background. In this case, even if the framework 340 is not updated, the electronic device 300 may simultaneously operate the first application program 351 and the second application program 357 using the life cycle manager 355. According to an embodiment, the life cycle manager 355 may determine an update time of the first application program 351 or the second application program 357, based on the status information (e.g., first life cycle event information and/or first additional information). For example, when both the first application program 351 and the second application program 357 are running in the background, the life cycle manager 355 may be set to reflect update information when either the first application program 351 or the second application program 357 is executed in the foreground.

According to an embodiment, the life cycle manager 355 may send a request for the status information (e.g., first life cycle event information and/or first additional information) about the first application program 351 to the framework 340 or the first application program 351. After the request, the life cycle manager 355 may receive the status information from the framework 340 or the first application program 351.

According to various embodiments, using the received status information (e.g., first life cycle event information and/or first additional information), the life cycle manager 355 may transmit, for example, a situation regarding a touch and drag on the first user interface 321 of the first application program 351 displayed on the display 320 to a legacy component 359 of the second application program 357. For example, using the received status information, the life cycle manager 355 may transmit, to the legacy component 359 of the second application program 357, a situation as to whether a key input event of having to execute the second application program 357 is transmitted. For example, using the received status information, the life cycle manager 355 may transmit, to the legacy component 359 of the second application program 357, a situation regarding whether the first application program 351 needs to move or update the second application program 357.

According to an embodiment, the legacy component 359 included in the second application program 357 may have a command of performing the overall control operations for the second application program 357 using the status information (e.g., first life cycle event information and/or first additional information) transmitted through the life cycle manager 355.

According to various embodiments, the second application program 357 may transmit second additional information to the first application program 351 using the life cycle manager 355. The second additional information may include, for example, call back information for the status information (e.g., first life cycle event information and/or first additional information) transmitted from the first application program 351. The second additional information may include, for example, life cycle information of the second application program 357. The second additional information may include, for example, coordinate information of the second application program 357 and location setting information of the first application program 351. The second additional information may include, for example, command information for explicitly operating the first application program 351 in accordance with a business logic of the second application program 357.

According to an embodiment, the display 320 may display the first user interface 321 related to the first application program 351 provided from the application layer 350. The display 320 may display the second user interface 322 related to the second application program 357 provided from the application layer 350. The display 320 may receive touch and drag signals inputted from the outside. The display 320 may activate (e.g., a foreground environment) the first application program 351 and/or the second application program 357, based on such an input signal.

According to various embodiments, the display 320 may perform an input function and a display function. The display 320 may include a touch panel. The touch panel may be implemented with a touch sensor based on a capacitive overlay scheme, a resistive overlay scheme, an infrared beam scheme, or the like, or implemented with a pressure sensor. In addition to the above sensors, all types of sensor devices capable of sensing contact or pressure of an object may be used for the touch panel of the embodiments. The touch panel is capable of detecting a user's touch input, generating a detection signal, and transmitting it to the processor 330. The detection signal may include coordinate data of a user's touch.

According to an embodiment, the processor 330 may be operatively connected to the memory 310 and the display 320. The processor 330 may be configured to perform an operation of managing the life cycles of the first and second application programs 351 and 357 executed in the electronic device 300. The processor 330 may be configured to execute instructions stored in the memory 310. The processor 330 may be configured to interface the framework 340 and the application layer 350 as the memory 310 is executed.

According to an embodiment, the processor 330 may be configured to enable the framework 340 to provide the application layer 350 with the status information (e.g., a life cycle event information and additional information) about the first application program 351 and/or the second application program 357 included in the application layer 350. The processor 330 may be configured to enable the framework 340 to receive from the application layer 350 the status information about the first application program 351 and/or the second application program 357 included in the application layer 350.

According to an embodiment, the processor 330 may be configured to enable the display 320 to display the first user interface 321 of the first application program 351 and/or the second user interface 322 of the second application program 357. The processor 330 may be configured to enable the life cycle manager 355 to request the status information (e.g., first life cycle event information and/or first additional information) about the first application program 351 from the first application program 351. In connection with the request, the processor 330 may be configured to enable the life cycle manager 355 to receive the status information (e.g., first life cycle event information and/or first additional information) about the first application program 351 from the first application program 351. The processor 330 may be configured to enable the display 320 to display the second user interface 322 of the second application program 357 including content generated based at least in part on the received status information (e.g., first life cycle event information and/or first additional information).

According to various embodiments, the processor 330 may include various processing circuitry and control the overall operations of the electronic device 300 and a signal flow between internal components, and may perform a function of processing data. The processor 330 may be include, for example, and without limitation, a central processing unit (CPU), an application processor, a communication processor, and the like. The processor 330 may be implemented with a single core processor or a multi-core processor, and may include at least one processor.

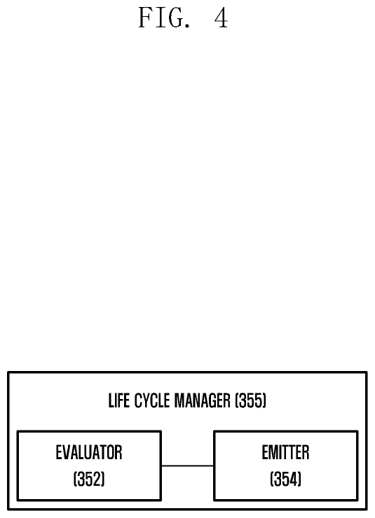

FIG. 4 is a block diagram illustrating an example configuration of a life cycle manager applied to an electronic device according to various embodiments. Referring to FIG. 4, the life cycle manager 355 according to various embodiments of the disclosure may include an evaluator (e.g., including various processing circuitry and/or executable program elements) 352 and an emitter (e.g., including various processing circuitry and/or executable program elements) 354.

According to various embodiments, the life cycle manager 355 may transmit the status information (e.g., first life cycle event information and/or first additional information), received from the first application program 351, to the legacy component 359 of the second application program 357 in order without duplication.

According to an embodiment, the evaluator 352 may transmit the status information, received from the first application program 351, to the second application program 357 when it is determined that the second application program 357 is in a situation of being able to receive the status information (e.g., first life cycle event information and/or first additional information) transmitted from the first application program 351.

According to various embodiments, without considering the situation of the second application program 357, the first application program 351 may transmit and share the status information (e.g., first life cycle event information and/or first additional information) to and with the second application program 357 using the life cycle manager 355. In this case, the second application program 357 should receive only status information of an acceptable situation from among the status information of the first application program 351 transmitted through the life cycle manager 355. The status information of an unacceptable situation may be ignored or, may be stored in the memory 310 and then accepted only upon a situation of being able to accept the status information. According to various embodiments, using the life cycle manager 355, the second application program 357 may receive the first life cycle event information, for example, onWindowFocusChanged, onConfigurationChanged, from among the status information transmitted from the first application program 351. In this example, the second application program 357 may receive the first life cycle event information such as onWindowFocusChanged or onConfigurationChanged and transmit it to the legacy component 359 of the second application program 357 in a situation where the second application program 357 is not ready to display the second user interface 322. In this case, the second application program 357 cannot receive the status information (e.g., the first life cycle event information) transmitted from the first application program 351, so that a malfunction may occur in the second application program 357. The evaluator 352 may determine and prepare for the above case.

According to an embodiment, the emitter 354 may transmit the status information (e.g., first life cycle event information and/or first additional information), transmitted from the first application program 351, to the second application program 357 in the order of occurrence. When determining that the second application program 357 should be in an active state (e.g., foreground environment), the emitter 354 may share and synchronize the status information (e.g., first life cycle event information and/or first additional information) of the first application program 351 with the second application program 357 so that the first and second application programs 351 and 357 may be used simultaneously. For example, if the status of the second application program 357 is onCreated (created initially), and if the status information transmitted from the first application program 351 is onResumed (displayed fully on screen), onStarted (starts to be displayed partly on screen) start) does not occur, and thereby the legacy component 359 may not operate normally. In this case, the emitter 354 may transmit the status information, transmitted from the first application program 351, to the legacy component 359 of the second application program 357 in the order of, for example, onCreated (created initially), onStarted (starts to be displayed partly on screen), and onResumed (displayed fully on screen).

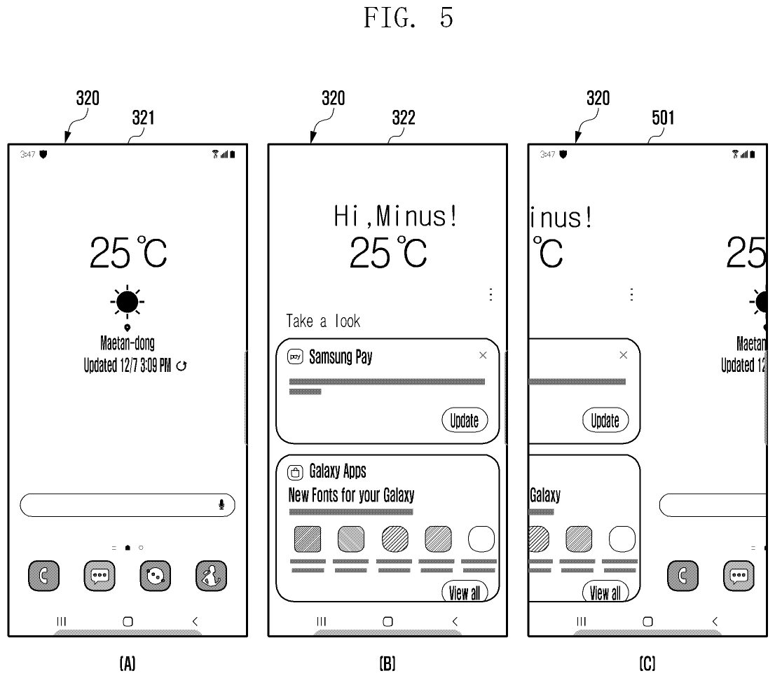

FIG. 5 is a diagram illustrating an example of managing life cycles of a plurality of applications executed in an electronic device according to various embodiments.

According to various embodiments, in FIG. 5, [A] represents the first user interface 321 of the first application program 351 (e.g., a user interface (UI) of the home application 251 in FIG. 2) displayed through the display 320 of the electronic device 300. In FIG. 5, [B] represents the second user interface 322 of the second application program 357 (e.g., a UI of the voice recognition application 267 in FIG. 2) displayed through the display 320 of the electronic device 300. In FIG. 5, [C] represents a screen 501 in which the first user interface 321 of the first application program 351 and the second user interface 322 of the second application program 357 displayed through the display 320 of the electronic device 300 are simultaneously provided.

According to an embodiment, when the first user interface 321 of the first application program 351 is activated (e.g., a foreground environment) on the display 320 and receives update information, or when the first user interface 321 is not displayed, the life cycle manager 355 may stop the operation of the second application program 357 so as to be deactivated (e.g., a background environment) and thereby reduce the usage of the memory 310. According to various embodiments, when the first user interface 321 of the first application program 351 is activated on the display 320 (e.g., a foreground environment), the second application program 351 may receive the status information of the first application program 351 through the life cycle manager 355 and may, for example, share update information of the first application program 351. In this case, as shown in [C] of FIG. 5, the electronic device 300 may display through the display 320 the screen 501 for simultaneously using the first user interface 321 of the first application program 351 and the second user interface 322 of the second application program 357.

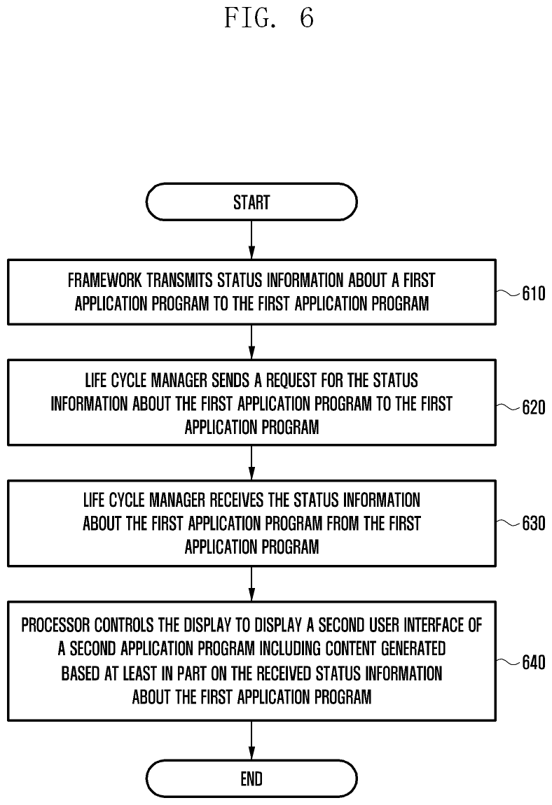

According to various embodiments, the first application program 351 may be a health-related program, and the second application program 357 may include a sports equipment-related program. In this case, the second application program 357 may share the status information transmitted from the first application program 351 using the life cycle manager 355. Accordingly, even when the first application program 351 is executed, the second application program 357 may share and use the update information of the first application program 351. FIG. 6 is a flowchart illustrating an example method for managing life cycles of a plurality of applications executed in an electronic device according to various embodiments.

The operations shown in FIG. 6 may be performed, for example, by the electronic device 300 shown in FIG. 3. For example, operations 610, 620, 630 and 640 (which may be referred to hereinafter as operations 610 to 640) shown in FIG. 6 may be performed by the processor 330 in the electronic device 300. At operation 610, the framework 340 may transmit status information (e.g., first life cycle event information and/or first additional information) about the first application program 351 to the first application program 351.

At operation 620, the life cycle manager 355 may send a request for the status information about the first application program 351 to the first application program 351.

At operation 630, the life cycle manager 355 may receive the status information about the first application program 351 from the first application program 351. At operation 640, the processor 330 may control the display to display on the display 320 the second user interface 322 of the second application program 357 including content generated based at least in part on the received status information about the first application program 351.

According to various embodiments of the disclosure, the second application program 357 is capable of sharing the status information about the first application program 351 transmitted through the framework 340, so that a plurality of application programs including the first and second application programs 351 and 357 may be linked to each other and thus operate at the same time.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents.

1. An electronic device comprising:
a display;
at least one processor connected to the display operatively; and
a memory connected to the processor operatively,
wherein the memory stores a first application program and a second application program each including a user interface, and
wherein the memory stores instructions that cause, when executed, the processor to:
request status information related to the first application program,
receive the status information related to the first application program, and
display, on the display, the user interface of the second application program including content generated based at least in part on the received status information.

2. The electronic device of claim 1, wherein the instructions cause the processor to:
provide a framework and an application layer that interfaces with the framework, and
request the status information from the application layer.

3. The electronic device of claim 1, wherein the instructions cause the processor to:
provide a framework and an application layer that interfaces with the framework, and
request the status information from the framework.

4. The electronic device of claim 1, wherein the second application program is associated with a voice-based assistant program.

5. The electronic device of claim 1, wherein the first application program is executed in a foreground or a background, and the second application program is executed in the background or the foreground, and
wherein when both the first application program and the second application program are executed in the background, and when there is update information in the received status information, the update information is reflected at a time when one of the first application program or the second application program is switched to the foreground.

6. The electronic device of claim 1, wherein the status information includes first life cycle event information including information for allocating or removing resources to or from the first application program or starting or stopping a predetermined operation.

7. The electronic device of claim 1, wherein the memory stores a life cycle manager, and
wherein the life cycle manager is configured to request and receive the status information about the first application program.

8. The electronic device of claim 7, wherein the life cycle manager is configured to transmit and share the received status information to and with the second application program, or to transmit the received status information to the second application program in a predetermined order.

9. A method for managing life cycles of a first application program and a second application program executed in an electronic device, the method comprising:
transmitting, by a framework, status information about the first application program to the first application program under control of a processor;
sending, by a life cycle manager, a request for the status information to the first application program;
receiving, by the life cycle manager, the status information about the first application program; and
displaying, on a display, a user interface of the second application program including content generated based at least in part on the received status information.

10. The method of claim 9, further comprising:
by the processor,
providing the framework and an application layer that interfaces with the framework, and
requesting the status information from the application layer.

11. The method of claim 9, further comprising:
by the processor,
providing the framework and an application layer that interfaces with the framework, and
requesting the status information from the framework.

12. The method of claim 9, wherein the second application program is associated with a voice-based assistant program.

13. The method of claim 9, wherein the first application program is executed in a foreground or a background, and the second application program is executed in the background or the foreground, and
wherein when both the first application program and the second application program are executed in the background, and when there is update information in the received status information, the update information is reflected at a time when one of the first application program or the second application program is switched to the foreground.

14. The method of claim 9, wherein the life cycle manager is configured to transmit and share the received status information to and with the second application program, or to transmit the received status information to the second application program in a predetermined order.

15. A computer-readable storage medium storing a program performing a method for managing life cycles of a first application program and a second application program executed in an electronic device, the method comprising:
transmitting, by a framework, status information about the first application program to the first application program under control of a processor;
sending, by a life cycle manager, a request for the status information to the first application program;
receiving, by the life cycle manager, the status information about the first application program; and
displaying, on a display, a user interface of the second application program including content generated based at least in part on the received status information.
